(19) United States
(12) Patent Application Publication
(10) Pub. No.: US 2006/0155027 A1
(43) Pub. Date: Jul. 13, 2006

(54) Blooming reduction of flame retardant olefin polymers

(75) Inventors: Cheng Q. Song, Green Brook, NJ (US); Ming Wu, Okemos, MI (US)

Correspondence Address: BASELL USA INC., INTELLECTUAL PROPERTY, 912 APPLETON ROAD, ELKTON, MD, 21921, US

(73) Assignee: Basell Poliolefine Italia s.r.l., Milan (IT)

(21) Appl. No.: 11/327,959

(22) Filed: Jan. 9, 2006

Related U.S. Application Data
(60) Provisional application No. 60/643,035, filed on Jan. 11, 2005.

(51) Int. Cl. C08K 5/13; C08G 73/10

(52) U.S. Cl. 524/341; 524/409

(57) ABSTRACT

A process for making a flame retardant olefin polymer material comprising: a) preparing a polymer mixture comprising: I. about 70.0 to about 98.0 wt % of a reactive, peroxide-containing olefin polymer material (A); II. about 1.5 to about 22.5 wt % of at least one non-polymerizable halogenated flame retardant containing at least one aliphatic, unsaturated carbon-carbon bond; and III. about 0.5 to about 7.5 wt % of at least one metal synergist; wherein the sum of components I+II+III is equal to 100 wt %; b) extruding or compounding in molten state the polymer mixture, thereby producing a melt mixture; and optionally c) pelletizing the melt mixture.

### FIELD OF THE INVENTION

This invention relates to a method for making flame retardant olefin polymers with reduced blooming on the polymer surface.

### BACKGROUND OF THE INVENTION

Flame retardant polymer materials have been prepared by blending flame retardants into the polymer matrix. The useful flame retardants include halogenated, non-halogenated, and phosphorus flame retardants. For examples, U.S. Pat. No. 5,605,962 discloses a flame retardant resin composition prepared by adding a phosphate-containing flame retardant into the grafted copolymer material. U.S. Pat. No. 5,543,447 discloses a plastic composition and method for making the same, comprising uniformly distributing a red amorphous phosphorus into a host polymer to prepare a flame retardant polymer material. However, it is known in the art that such dispersed flame retardants can often migrate to the surface of the plastic articles, causing low efficiency in flame retardancy and surface contamination.

It is also known that an olefin polymer material can be modified by a grafting polymerization where polymerizable vinyl monomers are initiated by active sites on the backbone of an olefin polymer material. The grafting sites can be produced by treatment with a peroxide or any other chemical compound which is a free radical polymerization initiator capable of extracting a hydrogen free radical from the polymer backbone, or by irradiation with high energy ionizing radiation. The active sites on the polyolefin can be formed either in the presence of grafting monomers, or by contacting with the monomers at a later stage. The free radicals produced in the reaction as a result of the degradation of peroxides or irradiation treatment act as initiators for polymerization of vinyl monomers.

For example, U.S. Pat. No. 5,652,281 discloses a method for making grafted olefin polymers by irradiating olefin polymer particles and treating with a vinyl monomer in liquid form under a non-oxidizing environment which is maintained throughout the process. The unreacted vinyl monomer is subsequently removed from the grafted olefin polymers while maintaining a substantially non-oxidizing environment.

Graft copolymers have also been made in an extruder, as disclosed in U.S. Pat. No. 3,862,265, in which an organic peroxide initiator was injected into the extruder to initiate the grafting reaction of polyolefins in molten state with vinyl monomers. The reactive extrusion, carried out on the polymer in molten state, offers many advantages such as a fast reaction rate and a simple reaction system. Nevertheless, such graft polymerization requires the use of organic peroxides during extrusion. Since peroxides are unstable and explosive chemicals, they require special safe handling procedures to minimize the risk. Moreover, the degradation products from the organic peroxide, such as t-butyl alcohol, undesirably remain in the final product and render the product unsuitable for certain applications.

Therefore, there is a need for a method of making a flame retardant olefin polymer material in which the flame retardant will not migrate to the surface of the polymer in order to obtain high flame retardancy and high surface purity polymer materials.

Accordingly, it is an object of this invention to prepare a flame retardant olefin polymer material having a flame retardant chemically bonded with the olefin polymer material without using an organic peroxide, in order to eliminate the above-mentioned difficulties associated with the handling of organic peroxides and to avoid the toxic by-products resulting from their use.

### SUMMARY OF THE INVENTION

In accordance with the present invention, a process for making flame retardant olefin polymer materials in molten state by using a reactive, peroxide-containing olefin polymer as an initiator is disclosed.

In one embodiment, the present invention relates to a process for making a flame retardant olefin polymer material comprising:
a) preparing a polymer mixture comprising:
   I. about 70.0 to about 98.0 wt % of a reactive, peroxide-containing olefin polymer material (A);
   II. about 1.5 to about 22.5 wt % of at least one non-polymerizable halogenated flame retardant containing at least one aliphatic, unsaturated carbon-carbon bond; and
   III. about 0.5 to about 7.5 wt % of at least one metal synergist;
wherein the sum of components I+II+III is equal to 100 wt %;
b) extruding or compounding in molten state the polymer mixture, thereby producing a melt mixture; and optionally
c) pelletizing the melt mixture.

In another embodiment, the present invention relates to a process for making a flame retardant olefin polymer mixture comprising:
a) preparing a polymer mixture comprising:
   I. about 10.0 to about 80.0 wt % of a reactive, peroxide-containing olefin polymer material (A);
   II. about 1.5 to about 22.5 wt % of at least one non-polymerizable halogenated flame retardant containing at least one aliphatic, unsaturated carbon-carbon bond;
   III. about 0.5 to about 7.5 wt % of at least one metal synergist; and
   IV. about 10.0 to about 80.0 wt % of an olefin polymer material (B);
wherein the sum of components I+II+III+IV is equal to 100 wt %;
b) extruding or compounding in molten state the polymer mixture, thereby producing a melt mixture; and optionally
c) pelletizing the melt mixture.

### BRIEF DESCRIPTION OF THE DRAWINGS

FIGS. 1-4 are FTIR spectra of Example 1 and Comparative Examples 1-3 before and after ethanol cleaning.

### DETAILED DESCRIPTION OF THE INVENTION

Olefin polymers suitable as a starting material for the reactive, peroxide-containing olefin polymer material (A) and the olefin polymer material (B) are a propylene polymer material, an ethylene polymer material, a butene-1 polymer material, or mixtures thereof. The olefin polymer used in the present invention can be selected from:
(a) a crystalline homopolymer of propylene having an isotactic index greater than about 80%, preferably about 90% to about 99.5%;
(b) a crystalline, random copolymer of propylene with an olefin selected from ethylene and C₄-C₁₀ α-olefins wherein the polymerized olefin content is about 1-10% by weight, preferably about 2% to about 8%, when ethylene is used, and about 1% to about 20% by weight, preferably about 2% to about 16%, when the C₄-C₁₀ α-olefin is used, the copolymer having an isotactic index greater than about 60%, preferably at least about 70%;
(c) a crystalline, random terpolymer of propylene and two olefins selected from ethylene and C₄-C₈ α-olefins wherein the polymerized olefin content is about 1% to about 5% by weight, preferably about 1% to about 4%, when ethylene is used, and about 1% to about 20% by weight, preferably about 1% to about 16%, when the C₄-C₁₀ α-olefins are used, the terpolymer having an isotactic index greater than about 85%; and
(d) an olefin polymer composition comprising:
   (i) about 10% to about 60% by weight, preferably about 15% to about 55%, of a crystalline propylene homopolymer having an isotactic index at least about 80%, preferably about 90 to about 99.5%, or a crystalline copolymer of monomers selected from (a) propylene and ethylene, (b) propylene, ethylene and a C₄-C₈ α-olefin, and (c) propylene and a C₄-C₈ α-olefin, the copolymer having a polymerized propylene content of more than about 85% by weight, preferably about 90% to about 99%, and an isotactic index greater than about 60%;
   (ii) about 3% to about 25% by weight, preferably about 5% to about 20%, of a copolymer of ethylene and propylene or a C₄-C₈ α-olefin that is insoluble in xylene at ambient temperature; and
   (iii) about 10% to about 80% by weight, preferably about 15% to about 65%, of an elastomeric copolymer of monomers selected from (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a polymerized diene and containing less than about 70% by weight, preferably about 10% to about 60%, most preferably about 12% to about 55%, of polymerized ethylene, and being soluble in xylene at ambient temperature and having an intrinsic viscosity of about 1.5 to about 6.0 dl/g;
wherein the total of (ii) and (iii), based on the total olefin polymer composition is about 50% to about 90% by weight, and the weight ratio of (ii)/(iii) is less than about 0.4, preferably 0.1 to 0.3, and the composition is prepared by polymerization in at least two stages;
(e) homopolymers of ethylene;
(f) random copolymers of ethylene and an α-olefin selected from C₃-C₁₀ α-olefins having a polymerized α-olefin content of about 1 to about 20% by weight, preferably about 2% to about 16%;
(g) random terpolymers of ethylene and two C₃-C₁₀ α-olefins having a polymerized α-olefin content of about 1% to about 20% by weight, preferably about 2% to about 16%;
(h) homopolymers of butene-1;
(i) copolymers or terpolymers of butene-1 with ethylene, propylene or C₅-C₁₀ alpha-olefin, the comonomer content ranging from about 1 mole % to about 15 mole %; and
(j) mixtures thereof.

Preferably, the olefin polymer is selected from:
(a) a crystalline homopolymer of propylene having an isotactic index greater than about 80%, preferably about 90% to about 99.5%; and
(b) a crystalline, random copolymer of propylene with an olefin selected from ethylene and C₄-C₁₀ α-olefins wherein the polymerized olefin content is about 1-10% by weight, preferably about 2% to about 8%, when ethylene is used, and about 1% to about 20% by weight, preferably about 2% to about 16%, when the C₄-C₁₀ α-olefin is used, the copolymer having an isotactic index greater than about 60%, preferably at least about 70%;

Most preferably, the olefin polymer is a propylene homopolymer having an isotactic index greater than about 90%.

The useful polybutene-1 homo or copolymers can be isotactic or syndiotactic and have a melt flow rate (MFR) from about 0.1 to 150 dg/min, preferably from about 0.3 to 100, and most preferably from about 0.5 to 75.

These butene-1 polymer materials, their methods of preparation and their properties are known in the art. Suitable polybutene-1 polymers can be obtained, for example, by using Ziegler-Natta catalysts with butene-1, as described in WO 99/45043, or by metallocene polymerization of butene-1 as described in WO 02/102811, the disclosures of which are incorporated herein by reference.

Preferably, the butene-1 polymer materials contain up to about 15 mole % of copolymerized ethylene or propylene. More preferably, the butene-1 polymer material is a homopolymer having a crystallinity of at least about 30% by weight measured with wide-angle X-ray diffraction after 7 days, more preferably about 45% to about 70%, most preferably about 55% to about 60%.

The starting material for the reactive, peroxide-containing olefin polymer (A) and the olefin polymer material (B) can be the same as or different from each other.

In a process to prepare the flame retardant olefin polymer material, the reactive, peroxide-containing olefin polymer material (A) can be present in an amount from about 70.0 to about 98.0% by weight, preferably about 75 to about 95.0%, more preferably about 80.0 to 92.0%, and most preferably about 85.0 to about 90.0%.

In a process to prepare the flame retardant olefin polymer mixture, the reactive, peroxide-containing olefin polymer material (A) can be present in an amount from about 10.0 to about 80.0% by weight, preferably from about 40 to about 70%, more preferably about 55.0 to 65.0%. The olefin polymer material (B) can be present in an amount from about 10.0 to about 80% by weight, preferably from about 20 to about 50%, more preferably about 30.0 to 40.0%.

The reactive, peroxide-containing olefin polymer has a peroxide concentration typically ranging from about 10 to about 200 milli-equivalent per kilogram of the polymer (meq/kg), and preferably ranging from about 20 to about 50.

The reactive, peroxide-containing olefin polymer may be prepared by using an irradiation and oxidation process by exposing the polyolefin starting material to high energy ionizing radiation in an essentially oxygen-free environment, i.e., an environment in which the active oxygen concentration is established and maintained at 0.004% by volume or less. The olefin polymer starting material is exposed to high-energy ionizing radiation under a blanket of inert gas, preferably nitrogen. The ionizing radiation should have sufficient energy to penetrate the mass of polymer material being irradiated to the extent desired. The ionizing radiation can be of any kind, but preferably includes electrons and gamma rays. More preferred are electrons beamed from an electron generator having an accelerating potential of 500-4,000 kilovolts. Satisfactory results are obtained at a dose of ionizing radiation of about 0.1 to about 15 megarads (“Mrad”), preferably about 0.5 to about 9.0 Mrad.

The term “rad” is usually defined as that quantity of ionizing radiation that results in the absorption of 100 ergs of energy per gram of irradiated material regardless of the source of the radiation using the process described in U.S. Pat. No. 5,047,446. Energy absorption from ionizing radiation is measured by the well-known convention dosimeter, a measuring device in which a strip of polymer film containing a radiation-sensitive dye is the energy absorption sensing means. Therefore, as used in this specification, the term “rad” means that quantity of ionizing radiation resulting in the absorption of the equivalent of 100 ergs of energy per gram of the polymer film of a dosimeter placed at the surface of the olefin material being irradiated, whether in the form of a bed or layer of particles, or a film, or a sheet.

The irradiated olefin polymer material is then oxidized in a series of steps. According to a preferred preparation method, the first treatment step consists of heating the irradiated polymer, in the presence of a first controlled amount of active oxygen greater than 0.004% by volume but less than 21% by volume, preferably less than 15% by volume, more preferably less than 8% by volume, and most preferably from 0.5% to 5.0% by volume, to a first temperature of at least 25° C. but below the softening point of the polymer, preferably about 25° C. to 140° C., more preferably about 40° C. to 100° C., and most preferably about 50° C. to 90° C. Heating to the desired temperature is accomplished as quickly as possible, preferably in less than 10 minutes. The polymer is then held at the selected temperature, typically for about 5 to 90 minutes, to increase the extent of reaction of the oxygen with the free radicals in the polymer. The holding time, which can be determined by one skilled in the art, depends upon the properties of the starting material, the active oxygen concentration used, the irradiation dose, and the temperature. The maximum time is determined by the physical constraints of the fluid bed used to treat the polymer.

In the second treatment step, the irradiated polymer is heated, in the presence of a second controlled amount of oxygen greater than 0.004% by volume but less than 21% by volume, preferably less than 15% by volume, more preferably less than 8% by volume, and most preferably from 0.5% to 5.0% by volume, to a second temperature of at least 25° C. but below the softening point of the polymer. Preferably, the second temperature is from 80° C. to less than the softening point of the polymer, and greater than the temperature of the first treatment step. The polymer is then held at the selected temperature and oxygen concentration conditions for about 10 to 300 minutes, preferably about 20 to 180 minutes, most preferably about 30 to 60 minutes, to minimize the recombination of chain fragments, i.e., to minimize the formation of long chain branches. The holding time is determined by the same factors discussed in relation to the first treatment step.

In the optional third step, the oxidized olefin polymer material is heated under a blanket of inert gas, preferably nitrogen, to a third temperature of at least 80° C. but below the softening point of the polymer, and held at that temperature for about 10 to about 120 minutes, preferably about 60 minutes. A more stable product is produced if this step is carried out. It is preferred to use this step if the reactive, peroxide-containing olefin polymer material is going to be stored rather than used immediately, or if the radiation dose that is used is on the high end of the range described above. The polymer is then cooled to a fourth temperature of about below 50° C. under a blanket of inert gas, preferably nitrogen, before being discharged from the bed. In this manner, stable intermediates are formed that can be stored at room temperature for long periods of time without further degradation.

As used in this specification, the expression “room temperature” or “ambient” temperature means approximately 25° C. The expression “active oxygen” means oxygen in a form that will react with the irradiated olefin polymer material. It includes molecular oxygen, which is the form of oxygen normally found in air. The active oxygen content requirement of this invention can be achieved by replacing part or all of the air in the environment by an inert gas such as, for example, nitrogen.

It is preferred to carry out the treatment by passing the irradiated polymer through a fluid bed assembly operating at a first temperature in the presence of a first controlled amount oxygen, passing the polymer through a second fluid bed assembly operating at a second temperature in the presence of a second controlled amount of oxygen, and then maintaining the polymer at a third temperature under a blanket of nitrogen, in a third fluid bed assembly. In commercial operation, a continuous process using separate fluid beds for the first two steps, and a purged, mixed bed for the third step is preferred. However, the process can also be carried out in a batch mode in one fluid bed, using a fluidizing gas stream heated to the desired temperature for each treatment step. Unlike some techniques, such as melt extrusion methods, the fluidized bed method does not require the conversion of the irradiated polymer into the molten state and subsequent re-solidification and comminution into the desired form. The fluidizing medium can be, for example, nitrogen or any other gas that is inert with respect to the free radicals present, e.g., argon, krypton, and helium.

The concentration of peroxide groups formed on the polymer can be controlled easily by varying the radiation dose during the preparation of the reactive, peroxide-containing olefin polymer and the amount of oxygen to which such polymer is exposed after irradiation. The oxygen level in the fluid bed gas stream is controlled by the addition of dried, filtered air at the inlet to the fluid bed. Air must be constantly added to compensate for the oxygen consumed by the formation of peroxides in the polymer.

Alternatively, the reactive, peroxide-containing olefin polymer materials could be prepared according to the following procedures. In the first treatment step, the polymer starting material was treated with 0.1 to 10 wt % of an organic peroxide initiator while adding a controlled amount of oxygen so that the olefin polymer material is exposed to greater than 0.004% but less than 21% by volume, preferably less than 15%, more preferably less than 8% by volume, and most preferably 1.0% to 5.0% by volume, at a temperature of at least 25° C. but below the softening point of the polymer, preferably about 25° C. to about 140° C. In the second treatment step, the polymer is then heated to a temperature of at least 25° C. up to the softening point of the polymer, preferably from 100° C. to less than the softening point of the polymer, at an oxygen concentration that is within the same range as in the first treatment step. The total reaction time is typically about 0.5 hour to four hours. After the oxygen treatment, the polymer is optionally treated at a temperature of at least 80° C. but below the softening point of the polymer, typically for 0.5 hour to about two hours, in an inert atmosphere such as nitrogen to quench any active free radicals.

Suitable organic peroxides include acyl peroxides, such as benzoyl and dibenzoyl peroxides; dialkyl and aralkyl peroxides, such as di-tert-butyl peroxide, dicumyl peroxide; cumyl butyl peroxide; 1,1,-di-tert-butylperoxy-3,5,5-trimethylcyclohexane; 2,5-dimethyl-1,2,5-tri-tert-butylperoxyhexane, and bis(alpha-tert-butylperoxy isopropylbenzene), and peroxy esters such as bis(alpha-tert-butylperoxy pivalate; tert-butylperbenzoate; 2,5-dimethylhexyl-2,5-di(perbenzoate); tert-butyl-di(perphthalate); tert-butylperoxy-2-ethylhexanoate, and 1,1-dimethyl-3-hydroxybutylperoxy-2-ethyl hexanoate, and peroxycarbonates such as di(2-ethylhexyl)peroxy dicarbonate, di(n-propyl)peroxy dicarbonate, and di(4-tert-butylcyclohexyl)peroxy dicarbonate. The peroxides can be used neat or in diluent medium. In all cases, whether or not a solvent or diluent is present, the amount of the organic peroxide given above is based on the actual organic peroxide content.

The reactive, peroxide-containing olefin polymers used in the process of the invention are easy to handle and may be stored for long periods of time without the need of specific storage requirement.

The non-polymerizable flame retardant contains at least one aliphatic, unsaturated carbon-carbon bond, which can be activated and attached to reactive sites on the reactive, peroxide-containing olefin polymer. The flame retardant is preferably a halogenated flame retardant, more preferably a flame retardant selected from tetrabromobisphenol A and its derivatives, and most preferably tetrabromobisphenol A bis (allylether). Multiple flame retardants from the same or different classes can be employed.

The total amount of the flame retardant used in the flame retardant olefin polymer material or the flame retardant olefin polymer mixture is about 1.5 to about 22.5 wt %, preferably about 3.0 to about 20.0 wt %, more preferably about 5.0 to about 15.0 wt %, and most preferably about 6.0 to about 12.0 wt %.

The metal synergist is used to enhance efficiency of the halogenated flame retardant in order to minimize the amount of the flame retardant and therefore, its adverse effects on the physical properties of the olefin polymer materials. The metal synergist is preferably an antimony compound, more preferably a compound selected from antimony trioxide, antimony pentoxide, sodium antimonate and mixtures thereof, and most preferably antimony trioxide.

The total amount of the metal synergist used in the flame retardant olefin polymer material or the flame retardant olefin polymer mixture is about 0.5 to about 7.5 wt %, preferably about 1.0 to about 6.0 wt %, more preferably about 1.5 to about 5.0 wt %, and most preferably about 2.0 to about 4.0 wt %.

The polymer composition of the present invention may also contain conventional additives, for instance, anti-acid stabilizers, such as, calcium stearate, hydrotalcite, zinc stearate, calcium oxide, and sodium stearate.

In preparation of the polymer mixture of the present invention, the reactive, peroxide-containing olefin polymer material, the olefin polymer material if any, the halogenated flame retardant, and the metal synergist can be combined at ambient temperature in conventional operations well known in the art; including but not limited to, drum tumbling, manual mixing, or with low or high speed mixers.

The resulting mixture is then extruded or compounded in molten state to carry out the grafting reaction in any conventional manner well known in the art, in batch or continuous mode; for example, by using a Banbury mixer, a kneading machine, a single screw extruder, a twin screw extruder or an autoclave equipped with adequate agitation.

The melt mixture can then be optionally pelletized according to conventional methods well know in the art.

Unless otherwise specified, the properties of the olefin polymer materials, compositions and other characteristics that are set forth in the following examples have been determined according to the test methods reported below:
Melt Flow Rate (“MFR”): ASTM D1238, units of dg/min; 230° C.; 2.16 kg; Polymer material with a MFR below 100, using full die; Polymer material with a MFR equal or above 0.100, using 1 die; unless otherwise specified.
Isotactic Index (“I.I.”): Defined as the percent of olefin polymer insoluble in xylene. The weight percent of olefin polymer soluble in xylene at room temperature is determined by dissolving 2.5 g of polymer in 250 ml of xylene at room temperature in a vessel equipped with a stirrer, and heating at 135° C. with agitation for 20 minutes. The solution is cooled to 25° C. while continuing the agitation, and then left to stand without agitation for 30 minutes so that the solids can settle. The solids are filtered with filter paper, the remaining solution is evaporated by treating it with a nitrogen stream, and the solid residue is vacuum dried at 80° C. until a constant weight is reached. These values correspond substantially to the isotactic index determined by extracting with boiling n-heptane, which by definition constitutes the isotactic index of polypropylene.
Peroxide Concentration: Quantitative Organic Analysis via Functional Groups, by S. Siggia et al., 4th Ed., NY, Wiley 1979, pp. 334-42.
Flammability Test: Underwriters Laboratories Inc. UL-94. The test sample was injection molded into flex bars with dimensions of 127 mm±5 mm, by 13 mm±0.5 mm, by 3.13 mm±0.05 mm.
Surface Characteristics: Fourier Transform Infrared Spectroscopy (FTIR) spectra were obtained by using ATR attachment on the surface of injection molded flex bars with dimensions of 127 mm±5 mm, by 13 mm±0.5 mm, by 3.13 mm±0.05 mm.
Molecular Weights and their Distribution: High temperature gel permeation chromatography (GPC, made by Waters Corp.) was used to analyze the weight average molecular weight, number average molecular weight and their distribution. The solvent used is trichlorobenzene.

In this specification, all parts, percentages and ratios are by weight unless otherwise specified.

The reactive, peroxide-containing olefin polymer materials are prepared according to the following procedures.

Preparation 1

A polypropylene homopolymer, having a MFR of 0.3 dg/min, and I.I. of 95.6%, commercially available from Basell USA Inc. was irradiated at 1.0 Mrad under a blanket of nitrogen. The irradiated polymer was then treated with 2.8% by volume of oxygen at ambient temperature for 60 minutes and then with 2.8% by volume of oxygen at 140° C. for an additional 60 minutes. The oxygen was then removed. The polymer was then heated at 140° C. under a blanket of nitrogen for 60 minutes, cooled and collected. The MFR of the resultant polymer material was 1291 dg/min. The weight average molecular weight was 63,000, the number average molecular weight was 20,000 and the molecular weight distribution was 3.1. The peroxide concentration was 26.5 meq/kg of polymer.

### EXAMPLE 1

A reactive, peroxide-containing olefin polymer (P1) prepared in Preparation 1 was mixed with tetrabromobisphenol A bis (ally ether), antimony trioxide, both commercially available from Great Lakes Chemical Corporation, and a stabilization package.

The materials were dry-blended and bag mixed with Irganox B225 antioxidant and calcium stearate. Irganox B225, which is a 1:1 blend of Irganox 1010 antioxidant and Irgafos 168 tris(2,4-di-t-butylphenyl)phosphite antioxidant, and calcium stearate are both commercially available from Ciba Specialty Chemicals Corporation.

The obtained polymer mixtures were then compounded in a 30 mm co-rotating intermeshing Leistritz LSM 34 GL twin-screw extruder commercially available from Leistritz AG, with a barrel temperature of 190° C. for the first three zones and a die temperature of 160° C. The throughput was 11.4 kg/hr, and the screw speed was 150 r.p.m. The polymer melt was pelletized and then dried. The pelletized polymer material was molded on a 5 oz Batterfeld injection molding machine at a mold temperature of 70° C.

### COMPARATIVE EXAMPLE 1

A reactive, peroxide-containing olefin polymer (P1) described in Example 1 was mixed with tetrabromobisphenol A, antimony trioxide, both commercially available from Great Lakes Chemical Corporation, and a stabilization package.

The compounding and sample preparation procedure is the same as that described in Example 1.

### COMPARATIVE EXAMPLE 2

A polypropylene homopolymer (H1), having a MFR of 440 dg/min, and I.I. of 97.0%, commercially available from Basell USA Inc., was mixed with tetrabromobisphenol A bis (ally ether), antimony trioxide and a stabilization package.

The compounding and sample preparation procedure is the same as that described in Example 1.

### COMPARATIVE EXAMPLE 3

A polypropylene homopolymer (H1) described in Comparative Example 2 was mixed with tetrabromobisphenol A, antimony trioxide and a stabilization package.

The compounding and sample preparation procedure is the same as that described in Example 1.

The composition of Example 1, and Comparative Examples 1-3 are reported in Table 1.

TABLE 1

| | | Comparative | Comparative | Comparative |
|---|---|---|---|---|
| Composition | Example 1 | Example 1 | Example 2 | Example 3 |
| Reactive, peroxide-containing | 1834 | 1834 | | |
| polymer (P1) (g) | | | | |
| Propylene Homopolymer (H1) (g) | 0 | 0 | 1834 | 1834 |
| Tetrabromobisphenol A bis (ally | 120 | 0 | 120 | 0 |
| ether) (g) | | | | |
| Tetrabromobisphenol A (g) | 0 | 120 | 0 | 120 |
| Antimony trioxide (g) | 40 | 40 | 40 | 40 |
| Irganox B225 (g) | 4.0 | 4.0 | 4.0 | 4.0 |
| Calcium Stearate (g) | 2.0 | 2.0 | 2.0 | 2.0 |

The flammability of the Examples evaluated under UL 94 test conditions is summarized in Table 2. Example 1 shows similar total flame time and total glow time as those of the samples containing propylene homopolymer only, indicating that the sample prepared using a reactive, peroxide-containing olefin polymer achieves good flame retardancy.

TABLE 2

| | | Comparative | Comparative | Comparative |
|---|---|---|---|---|
| Flammability | Example 1 | Example 1 | Example 2 | Example 3 |
| Total flame time | 0 | 5.0 | 0 | 0 |
| (sec.) | | | | |
| Total flame and | 0 | 5.0 | 0 | 0 |
| glow time (sec.) | | | | |

The degree of blooming of the flame retardant on the polymer surface was analyzed by using Fourier Transform Infrared Spectroscope (ATR method), FTS-40, made by Bio-Rad Laboratories. The sample surface of the Example and the Comparative Examples is wipe-cleaned at least twice by using a cotton applicator soaked with ethanol before taking a spectrum labeled as “after ethanol cleaning”.

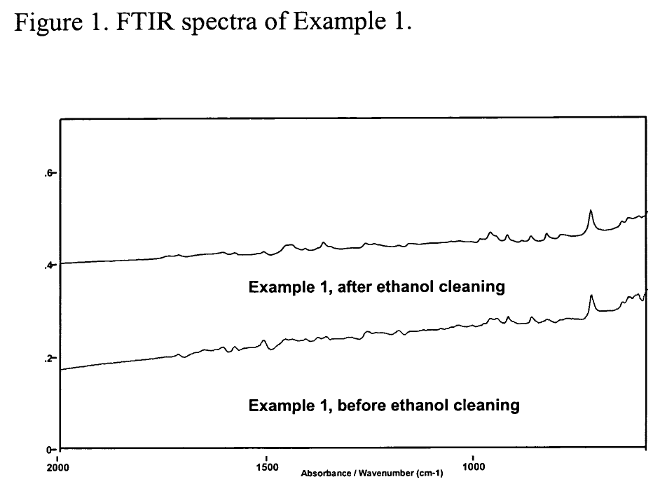

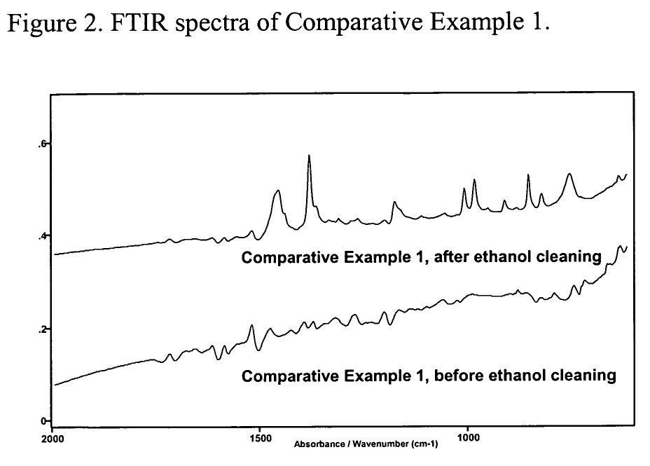

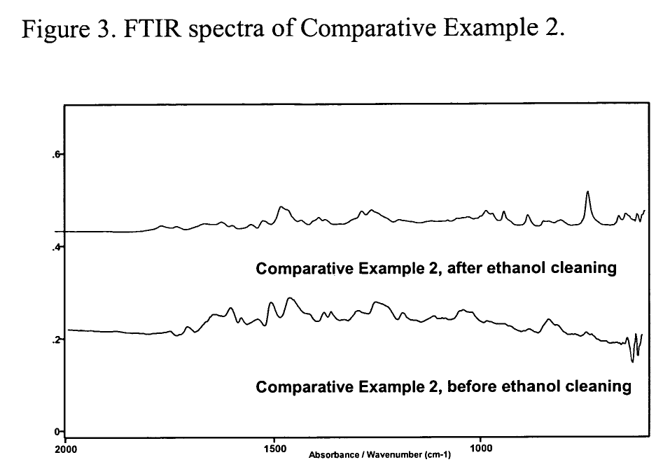

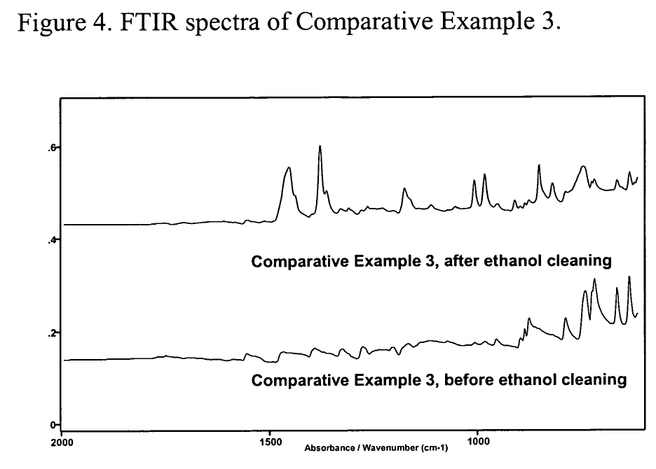

As shown in FIG. 1, the surface characteristics of Example 1 do not change significantly before and after the surface was wipe-cleaned by using ethanol. It indicates that the flame retardant does not bloom to the polymer surface due to the formation of chemical bonds between the flame retardant and the olefin polymer material. In contrast, Comparative Example 1 (FIG. 2) shows very different FTIR spectra indicating the polymer surface was covered by the flame retardant before the surface was wiped-cleaned by ethanol. Therefore, a flame retardant containing no unsaturated bonds could not be chemically bonded to the polymer even if a reactive, peroxide-containing olefin polymer is used in the composition. Similarly, blooming on the polymer surface was also observed in Comparative Examples 2 and 3 (FIGS. 3-4) which contain no reactive, peroxide-containing olefin polymer in the formulation because no chemical bonds between the flame retardant and the olefin polymer material would be formed.

Other features, advantages and embodiments of the invention disclosed herein will be readily apparent to those exercising ordinary skill after reading the foregoing disclosures. In this regard, while specific embodiments of the invention have been described in considerable detail, variations and modifications of these embodiments can be effected without departing from the spirit and scope of the invention as described and claimed.

What is claimed is:

1. A process for making a flame retardant olefin polymer material comprising:
a) preparing a polymer mixture comprising:
I. about 70.0 to about 98.0 wt % of a reactive, peroxide-containing olefin polymer material (A);
II. about 1.5 to about 22.5 wt % of at least one non-polymerizable halogenated flame retardant containing at least one aliphatic, unsaturated carbon-carbon bond; and
III. about 0.5 to about 7.5 wt % of at least one metal synergist;
wherein the sum of components I+II+III is equal to 100 wt %;
b) extruding or compounding in molten state the polymer mixture, thereby producing a melt mixture; and optionally
c) pelletizing the melt mixture.

2. The process of claim 1 wherein the reactive, peroxide-containing olefin polymer material (A) is prepared from an olefin polymer starting material selected from:
(a) a crystalline homopolymer of propylene having an isotactic index greater than about 80%;
(b) a crystalline, random copolymer of propylene with an olefin selected from ethylene and C₄-C₁₀ α-olefins wherein the polymerized olefin content is about 1-10% by weight when ethylene is used, and about 1% to about 20% by weight when the C₄-C₁₀ α-olefin is used, the copolymer having an isotactic index greater than about 60%;
(c) a crystalline, random terpolymer of propylene and two olefins selected from ethylene and C₄-C₈ α-olefins wherein the polymerized olefin content is about 1% to about 5% by weight when ethylene is used, and about 1% to about 20% by weight when the C₄-C₁₀ α-olefins are used, the terpolymer having an isotactic index greater than about 85%;
(d) an olefin polymer composition comprising:
(i) about 10% to about 60% by weight of a crystalline propylene homopolymer having an isotactic index at least about 80% or a crystalline copolymer of monomers selected from (a) propylene and ethylene, (b) propylene, ethylene and a C₄-C₈ α-olefin, and (c) propylene and a C₄-C₈ α-olefin, the copolymer having a polymerized propylene content of more than about 85% by weight, and an isotactic index greater than about 60%;
(ii) about 3% to about 25% by weight of a copolymer of ethylene and propylene or a C₄-C₈ α-olefin that is insoluble in xylene at ambient temperature; and
(iii) about 10% to about 80% by weight of an elastomeric copolymer of monomers selected from (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a polymerized diene and containing less than about 70% by weight of polymerized ethylene, and being soluble in xylene at ambient temperature and having an intrinsic viscosity of about 1.5 to about 6.0 dl/g;
wherein the total of (ii) and (iii), based on the total olefin polymer composition is about 50% to about 90% by weight, and the weight ratio of (ii)/(iii) is less than about 0.4, and the composition is prepared by polymerization in at least two stages;
(e) homopolymers of ethylene;
(f) random copolymers of ethylene and an α-olefin selected from C₃-C₁₀ α-olefins having a polymerized α-olefin content of about 1 to about 20% by weight;
(g) random terpolymers of ethylene and C₃-C₁₀ α-olefins having a polymerized α-olefin content of 1 to 20% by weight;
(h) homopolymers of butene-1;
(i) copolymers or terpolymers of butene-1 with ethylene, propylene or C₅-C₁₀ alpha-olefin, the comonomer content from about 1 mole % to about 15 mole %; and
(j) mixtures thereof.

3. The process of claim 2 wherein the starting material is a crystalline homopolymer of propylene having an isotactic index greater than 80%.

4. A process for making a flame retardant olefin polymer mixture comprising:
a) preparing a polymer mixture comprising:
I. about 10.0 to about 80.0 wt % of a reactive, peroxide-containing olefin polymer material (A);
II. about 1.5 to about 22.5 wt % of at least one non-polymerizable halogenated flame retardant containing at least one aliphatic, unsaturated carbon-carbon bond;
III. about 0.5 to about 7.5 wt % of at least one metal synergist; and
IV. about 10.0 to about 80.0 wt % of an olefin polymer material (B);
wherein the sum of components I+II+III+IV is equal to 100 wt %;
b) extruding or compounding in molten state the polymer mixture, thereby producing a melt mixture; and optionally
c) pelletizing the melt mixture.

5. The process of claim 4 wherein the reactive, peroxide-containing olefin polymer material (A) is prepared from an olefin polymer starting material selected from:
(a) a crystalline homopolymer of propylene having an isotactic index greater than about 80%;
(b) a crystalline, random copolymer of propylene with an olefin selected from ethylene and C₄-C₁₀ α-olefins wherein the polymerized olefin content is about 1-10% by weight when ethylene is used, and about 1% to about 20% by weight when the C₄-C₁₀ α-olefin is used, the copolymer having an isotactic index greater than about 60%;
(c) a crystalline, random terpolymer of propylene and two olefins selected from ethylene and C₄-C₈ α-olefins wherein the polymerized olefin content is about 1% to about 5% by weight when ethylene is used, and about 1% to about 20% by weight when the C₄-C₁₀ α-olefins are used, the terpolymer having an isotactic index greater than about 85%;
(d) an olefin polymer composition comprising:
(i) about 10% to about 60% by weight of a crystalline propylene homopolymer having an isotactic index at least about 80% or a crystalline copolymer of monomers selected from (a) propylene and ethylene, (b) propylene, ethylene and a C₄-C₈ α-olefin, and (c) propylene and a C₄-C₈ α-olefin, the copolymer having a polymerized propylene content of more than about 85% by weight, and an isotactic index greater than about 60%;
(ii) about 3% to about 25% by weight of a copolymer of ethylene and propylene or a C₄-C₈ α-olefin that is insoluble in xylene at ambient temperature; and
(iii) about 10% to about 80% by weight of an elastomeric copolymer of monomers selected from (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a polymerized diene and containing less than about 70% by weight of polymerized ethylene, and being soluble in xylene at ambient temperature and having an intrinsic viscosity of about 1.5 to about 6.0 dl/g;
wherein the total of (ii) and (iii), based on the total olefin polymer composition is about 50% to about 90% by weight, and the weight ratio of (ii)/(iii) is less than about 0.4, and the composition is prepared by polymerization in at least two stages;
(e) homopolymers of ethylene;
(f) random copolymers of ethylene and an α-olefin selected from C₃-C₁₀ α-olefins having a polymerized α-olefin content of about 1% to about 20% by weight;
(g) random terpolymers of ethylene and two C₃-C₁₀ α-olefins having a polymerized α-olefin content of about 1% to about 20% by weight;
(h) homopolymers of butene-1;
(i) copolymers or terpolymers of butene-1 with ethylene, propylene or C₅-C₁₀ alpha-olefin, the comonomer content from about 1 mole % to about 15 mole %; and
(j) mixtures thereof.

6. The process of claim 5 wherein the starting material is a crystalline homopolymer of propylene having an isotactic index greater than 80%.

7. The process of claim 4 wherein the olefin polymer material (B) is selected from:
(a) a crystalline homopolymer of propylene having an isotactic index greater than about 80%;
(b) a crystalline, random copolymer of propylene with an olefin selected from ethylene and C₄-C₁₀ α-olefins wherein the polymerized olefin content is about 1-10% by weight when ethylene is used, and about 1% to about 20% by weight when the C₄-C₁₀ α-olefin is used, the copolymer having an isotactic index greater than about 60%;
(c) a crystalline, random terpolymer of propylene and two olefins selected from ethylene and C₄-C₈ α-olefins wherein the polymerized olefin content is about 1% to about 5% by weight when ethylene is used, and about 1% to about 20% by weight when the C₄-C₁ α-olefins are used, the terpolymer having an isotactic index greater than about 85%;
(d) an olefin polymer composition comprising:
(i) about 10% to about 60% by weight of a crystalline propylene homopolymer having an isotactic index at least about 80% or a crystalline copolymer of monomers selected from (a) propylene and ethylene, (b) propylene, ethylene and a C₄-C₈ α-olefin, and (c) propylene and a C₄-C₈ α-olefin, the copolymer having a polymerized propylene content of more than about 85% by weight, and an isotactic index greater than about 60%;
(ii) about 3% to about 25% by weight of a copolymer of ethylene and propylene or a C₄-C₈ α-olefin that is insoluble in xylene at ambient temperature; and
(iii) about 10% to about 80% by weight of an elastomeric copolymer of monomers selected from (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a polymerized diene and containing less than about 70% by weight of polymerized ethylene, and being soluble in xylene at ambient temperature and having an intrinsic viscosity of about 1.5 to about 6.0 dl/g;
wherein the total of (ii) and (iii), based on the total olefin polymer composition is about 50% to about 90% by weight, and the weight ratio of (ii)/(iii) is less than about 0.4, and the composition is prepared by polymerization in at least two stages;
(e) homopolymers of ethylene;
(f) random copolymers of ethylene and an α-olefin selected from C₃-C₁₀ α-olefins having a polymerized α-olefin content of about 1% to about 20% by weight;
(g) random terpolymers of ethylene and two C₃-C₁₀ α-olefins having a polymerized α-olefin content of about 1% to about 20% by weight;
(h) homopolymers of butene-1;
(i) copolymers or terpolymers of butene-1 with ethylene, propylene or C₅-C₁₀ alpha-olefin, the comonomer content from about 1 mole % to about 15 mole %; and
(j) mixtures thereof.

8. The process of claim 7 wherein the olefin polymer material (B) is a crystalline homopolymer of propylene having an isotactic index greater than 80%.

9. The process of claim 1 or claim 4 wherein the non-polymerizable flame retardant is selected from tetrabromobisphenol A and its derivatives.

10. The process of claim 9 wherein the non-polymerizable flame retardant is tetrabromobisphenol A bis (allyl ether).

11. The process of claim 1 or claim 4 wherein the metal synergist is selected from: antimony trioxide, antimony pentoxide, sodium antimonate and mixtures thereof.

12. The process of claim 11 wherein the metal synergist is antimony trioxide.
